(19) United States
(12) Patent Application Publication
(10) Pub. No.: US 2008/0106203 A1
(43) Pub. Date: May 8, 2008

(54) Arc Tube for a High Intensity Discharge Lamp

(76) Inventors: Gregory M. Gratson, Ballston Lake, NY (US); James A. Brewer, Scotia, NY (US); Venkat S. Venkataramani, Clifton Park, NY (US); Mohamed Rahmane, Clifton Park, NY (US); Bernard P. Bewlay, Niskayuna, NY (US); James S. Vartuli, Rexford, NY (US); Istvan Csanyi, Taller (HU)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/556,823

(22) Filed: Nov. 6, 2006

(51) Int. Cl. H01J 61/30; H01J 63/04; H01J 17/16

(52) U.S. Cl. 313/634; 313/573; 313/493

(57) ABSTRACT

An arc tube in a high intensity discharge lamp comprises an arc body comprising a single-phase first ceramic material has a first elemental composition, and the arc body has a sealed chamber. At least two legs are attached to the arc body, and at least one of the legs has a single-phase second ceramic material having a second elemental composition that is different from the first elemental composition. An electrode is positioned within a respective leg, each electrode has a tip positioned within the chamber and the tips of the electrodes are spaced apart forming an arc region there between.

### FIELD OF THE INVENTION

An embodiment of the invention pertains to ceramic materials and methods of manufacturing ceramic components used in lighting applications. More specifically, this invention relates to high intensity discharge lamps and the ceramic materials used to manufacture such lamps.

### BACKGROUND OF THE INVENTION

High intensity discharge (“HID”) lamps are typically used when high levels of light are needed over large areas such as gymnasiums, warehouses, parking lots etc. The HID lamps provide high lumen output and high-energy efficiency. Within the automotive industry, HID lamps are replacing conventional incandescent halogen lights used for automotive headlamps. In an HID lamp, light is generated by means of an electric discharge that takes place between two metal electrodes enclosed within a sealed envelope or arc tube. At least with respect to automotive headlamps, the arc tube is composed of quartz, because quartz has a relatively high in-line transmission of light at wavelengths within the visible light spectrum.

The discharge medium in quartz metal halide lamps consist of a mixture of xenon, mercury, sodium iodide (NaI) and/or scandium iodide (ScI₃), wherein the surrounding envelope, or arc-tube, is made of quartz with tungsten electrodes protruding within the envelope. In operation, the lamp size is kept small enough for optical coupling purposes. Further, the lamps that are required to meet the automotive industry standard of starting fast by delivering at least eighty percent of their steady state lumens no later than four seconds from the point at which they are turned on. The small lamp size and fast start requirements result in higher wall thermal loading, which in turn poses some limits on the quartz envelope material, and significant thermal stresses in the arc-tube, especially near the electrode roots. These limitations result in shortening the lamp life and also decreasing reliability of the lamp.

Ceramic materials, such as polycrystalline alumina (PCA) and yttrium aluminum garnet (YAG) are some times used as an envelope material in HID lamps. Ceramic arc tubes can withstand higher temperatures than quartz lamps; and, the cold spot temperature in ceramic lamps can be driven to a high enough value to evaporate the metal halide dose and produce enough vapor pressure for both the light emitting elements and the buffer gas.

The YAG ceramic has some advantages relative to the PCA ceramic including a high level of transparency, mechanical strength and thermal stability. In addition, YAG has a coefficient of thermal expansion (“CTE”) that is comparable to that of PCA; therefore a YAG arc tube can be used with the Nb—Mo—W electrode assembly in existing ceramic metal halide lamps. In ceramic HID arc tubes, the Nb of the electrode oxidizes at high temperatures if burned in air, which causes embrittlement and a loss of conductivity in the electrode. Encasing the CMH tube within a glass-outer jacket or “shroud” minimizes the oxidation of Nb. However, the addition of the glass shroud to the lamp system increases the cost of the lamp. In addition, the size of the lamp is increased, which may limit the different applications for the lamp.

Other electrode assemblies of ceramic metal halide lamps include a molybdenum-rhenium (Mo—Re) alloy lead in conjunction with a tungsten tip wherein the ceramic of the arc tube is PCA. This type of assembly can be used without a shroud due to the oxidation resistance of the Mo—Re assembly. As previously noted, PCA has poor transparency relative to YAG and PCA is not acceptable for optical applications such as automotive headlamps or video projection. However, YAG cannot be combined with a Mo—Re electrode assembly because of the value of the coefficient of thermal expansion of YAG does not match the coefficient of thermal expansion of the Mo—Re electrode assembly. For example the coefficient of thermal expansion for YAG at 1000 K is 8.51×10⁻⁶ K⁻¹, and the coefficient of thermal expansion for a Mo—Re electrode is 6.05×10⁻⁶ K⁻¹. Accordingly, an arc tube used for optical applications such as automotive headlamps and video projection wherein the arc tube is composed of yttrium aluminum garnet ceramic material is not available with a Re—Mo electrode assembly

### BRIEF DESCRIPTION OF THE INVENTION

An arc tube for a high intensity discharge lamp comprises an arc body having a sealed chamber, at least two legs attached to the arc body and a pair of electrodes. Each electrode is disposed within a respective leg and has a tip positioned within the chamber. The tips of the electrodes are spaced apart forming an arc region there between. The arc body is composed of a first polycrystalline ceramic material; and, the legs are composed of a second polycrystalline material that is different from, or not the same as the first polycrystalline ceramic material. The difference in the two ceramic materials may be found in the composition of the ceramics. That is, the arc body is composed of a single-phase first ceramic material that comprises a first elemental composition. The legs are composed of a single-phase second ceramic material comprising a second elemental composition that is different from the first elemental composition of the ceramic material of the arc body.

In addition, or alternatively, the difference in the two ceramic materials may be found in the coefficient of thermal expansion for each of the ceramics. In order for the arc tube, and lamp, to reliably operate the difference between the coefficient of thermal expansion for each of the first ceramic material and second ceramic material, should be should be as small as possible.

In one embodiment, the arc body is composed of a transparent sintered yttrium aluminum garnet (YAG) ceramic, and the legs are composed of a polycrystalline aluminum oxide (PCA) ceramic. The electrodes are composed of a combination of metals including tungsten for the tip and a lead assembly including molybdenum or molybdenum(Mo) and niobium wherein the molybdenum alloy is disposed between the tungsten and niobium. In another configuration, the electrodes are composed of tungsten and an alloy of Mo and rhenium (Re). Such an arc tube construction gains the benefits of the transparency of the YAG ceramic.

Co-sintering the arc body with the PCA legs forms a reliable bond between the YAG arc body and PCA legs. The PCA legs may be pre-sintered to shrink the legs to fit into the YAG arc body. The arc body is not pre-sintered, and, at the stage prior to sintering, is composed of a mixture of yttrium oxide powder and aluminum oxide powder doped with Si-containing compounds and Mg-containing compounds. During co-sintering of the components, the powder mixture of the arc body undergoes a solid-state reaction and converts to YAG. In as much as, the arc body is not pre-sintered, it shrinks more than the legs placing a compressive stress on the legs. This compressive stress drives diffusion between the material in the body and legs. The solid-state reaction takes place in part at the interface of the legs and arc body enhancing the diffusion between the YAG and the PCA to create a strong mechanical bond between the arc body and the legs.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a sectional view of an arc tube.

FIG. 2 is an expanded sectional view of a leg and electrode of an arc tube.

FIG. 3 is a photograph of a cross-section of a YAG arc body sintered to a PCA leg of an arc tube.

FIG. 4 is a photograph of a cross-section of an interface of between a YAG arc body and PCA leg of an arc tube.

### DESCRIPTION OF THE INVENTION

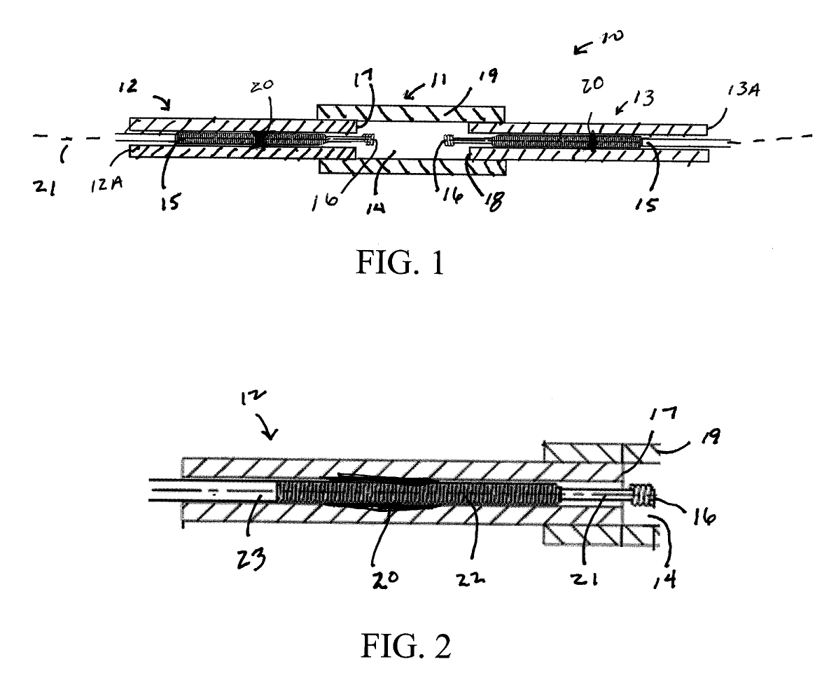

With respect to FIG. 1, a sectional view of an arc tube 10 for a high intensity discharge lamp is illustrated. The arc tube 10 has a typical construction for a high intensity discharge lamp including an arc body 11. A first leg 12 and a second leg 13 are integrally connected to the arc body 11. Each leg 12 and 13 extends from an opposing side of the body 11. An electrode 15 is secured within each of the legs 12 and 13 and terminates in a chamber 14 formed in the arc body 11 of the lamp 10. The tips 16 of the electrodes 15 are spaced apart a determined distance within the chamber 14, forming an arc region between the electrode tips 16. As shown in FIG. 2, a frit 20, composed of known materials such as dialuminum trioxide (Al₂O₃) or silica (SiO₂), is disposed between the electrode 15 and an interior surface of legs 12 and 13 and seals the chamber 14.

In one embodiment the arc body 11 is composed of a single-phase first ceramic material having a known first elemental composition; and, the legs are composed of a single-phase ceramic material having a known second elemental composition that is different than the first elemental composition. The term “phase” as used herein means a homogeneous, physically distinct, and mechanically separable portion of matter present in a non-homogeneous physicochemical system. The term “elemental” shall refer to the elements found in the periodic table, so the ceramic material of the arc body has elements some of which are not the same as the elements present in the ceramic material of the legs, or vice versa.

In an embodiment the arc body 11 may be composed of a polycrystalline yttrium aluminum garnet (YAG) ceramic and the legs 12 and 13 may be composed of polycrystalline alumina ceramic. The YAG may have an in-line transmission of up to 75% or greater, so the arc tube 10 can be used in forward lighting or optical applications such as automotive headlamps or video projection. However, the in-line transmission of the YAG may vary as needed for various lighting applications.

In one embodiment, and as shown in FIG. 2, each of the electrodes 15 has three sections including a first section 21 that has the tip 16 disposed within the chamber 14, a second section 22 that is disposed between the first section 21 and a third section 23, which is a lead that is distal to the first section 21. In one embodiment, the first section comprises tungsten (W), the second section comprises molybdenum (Mo) and the third section comprises rhenium (Re). In another configuration the electrode may be composed only of two sections, wherein the first section comprises tungsten (W) and the second section comprises an alloy of molybdenum (Mo) and rhenium (Re). However, the composition of the electrode is not limited to these elements; nor, is the configuration limited to three sections. The composition and configuration of the electrode is dependant on parameters such as the particular lighting application, the composition of the arc body and legs, respective coefficients of thermal expansion for the electrode and the composition of the legs etc. Moreover, the electrode may include more or fewer sections composed of a single or different conductive metals or metal alloys.

In one embodiment in an arc tube for use in forward lighting applications, such as automotive headlamps, the arc tube 10 is about 34 mm in length measured from a free end 12A of leg 12 to a free end 13A of leg 13. With an arc gap of 4 mm, the legs are about 15 mm in length so the electrode 15 may be at least 15 mm in length. The length of the frit 20 may be about 7 mm. When the electrode is composed of a combination of tungsten tip and a Mo—Re alloy lead, as described above, the frit may be about 7 mm. In this manner, the vapor pressure can be increased within the chamber 14, which increases the cold spot temperature within the chamber during operation of a lamp resulting in higher lumens output. Note, dimensions may vary according to lighting applications; accordingly, the size of the components will vary. For example, the inside diameter of the arc tube can range from 1.4 mm to 5 mm; the arc tube wall thickness may range from about 0.3 mm to about 1.2 mm; and, the length of the arc tube may range from about 5 mm to about 16 mm.

### Formation of Polycrystalline Alumina Leg

The PCA arc tubes can be formed using known materials and forming process. In forming PCA tubes for the present invention an alumina powder acquired from Baikowski had a particle surface area of 3 m²/gram. A wax base powder was used as the binder system to form a homogenous mixture containing approximately 56% by volume of the alumina powder. The legs were formed using an injection molder. After the PCA legs were formed they were heated at about 1050° C. to burn off any contaminants. The PCA legs were then pre-sintered at 1275° C. for thirty minutes under atmospheric conditions to achieve the desired shrinkage for the below described co-sintering with YAG arc tube.

### Preparation of Oxide Powder Mixture to be Converted to YAG

The YAG composing the arc body and the arc body itself may be fabricated from available yttrium oxide powders and aluminum oxide powders using known wet chemistry procedures, or solid state reactions of a mixture of these oxide powders. Typically, dopants such as SiO₂ and MgO are added to oxide powder mixture to promote densification and inhibit grain growth during the sintering phase of making the arc body. The arc body can be formed from known forming processes such as extrusion, injection molding or slip casting.

With respect to an embodiment of the invention, the arc body 11 is composed of a transparent polycrystalline yttrium aluminum garnet that is produced from a sinter-induced solid-state reaction of a stoichiometric mixture of an yttria powder and alumina powder. This powder mixture is doped with SiO₂ and MgO, and sintered to produce the yttrium aluminum garnet (YAG) having a high level of transparency that can be easily processed to form desired shapes, as the arc body 11 and legs 12 and 13, through extrusion and other methods. Ceramic discs having this yttrium aluminum garnet composition were fabricated and tested to consistently display an in-line transmission of greater than seventy-five percent.

In the preparation of the YAG, an amount of yttrium oxide (Y₂O₃) powder is combined with an amount of aluminum oxide (Al₂O₃) powder. The powders used in the fabrication process are preferably inexpensive, engineered-grade high purity powders. For example, the yttria powder may be purchased from Pacific Industrial Development Company (“PIDC”) located in Ann Arbor, Mich., which powder has a particle surface area of about 2 m²/g to about 3 m²/g. The alumina powder may be obtained from Baikowski USA, located in Pittsburgh, Pa., and has a particle size of about 0.3 microns to about 0.4 microns, and a particle surface area 10 m²/g, which is consistent with alumina powders used to fabricate polycrystalline alumina for ceramic metal halide lamps. In an embodiment, the particular ratio of particle surface area of 18:10, yttria to alumina; however, the particle surface area of yttrium oxide may range from about 9 m²/g to about 36 m²/g, and the particle surface area of aluminum oxide may range from about 3 m²/g to about 30 m²/g.

Stoichiometric amounts of the yttria powder and alumina powder are combined. For example, in tests conducted in the fabrication of ceramic discs and arc tube components, about 200 grams of yttria powder was combined with about 144.6 grams of the alumina powder to achieve a 3:5 molar ration of yttrium to aluminum. Prior to mixing the powders, the yttria powder was ball milled for about forty-eight hours to reduce particle size and increase the surface area to about 18 m²/gram of powder. The particle surface area of the yttria powder is thereby increased to make the yttria powder more reactive in a sintered induced solid-state reaction.

Sintering aids, or dopants, including SiO₂ and MgO, are added to the powder mixture. The SiO₂ was added in the form of a liquid tetraethylorthosilicate. In particular, 0.77 grams of the liquid tetraethylorthosilicate was added to the powder mix. In addition, MgO in the form of the salt, magnesium acetate, is added to the powder mix. In particular, 1.8 grams of the magnesium acetate was added to the powder mixture. These respective amounts of the silica and magnesium dopants were added to achieve a desired concentration of about 420 ppm by weight of Si to YAG and 270 ppm by weight of Mg to YAG. Other concentrations of the dopants may also be used in the YAG ceramic. For example the concentration of Si may be in the range of 200 ppm to 500 ppm by weight of Si to YAG; and, the concentration of Mg may be in the range of 150 ppm to 600 ppm by weight of Mg to YAG.

Approximately 0.5 liters of ethanol was then added to the mixture of the yttria powder, alumina powder and dopants. The mixture was shaken and then roll-milled for about twelve hours to homogenously disperse the dopants in the powder mixture. Known mixing and milling techniques such as energy mixing, vibratory mixing, static mixing, jet milling, ball milling and the like may be used. A YAG medium was used during the shaking and roll-milling procedures. Typical media used in shaking and milling procedures when manufacturing ceramics from powders include alumina media and/or zirconia media; however, it was determined that such media used in the present application may contaminate the mixture and alter the stoichiometry of the reaction during the sintering process, adversely affecting the transparency of the ceramic discs. The YAG media may be produced using the method or process described herein, including the below-described sintering schedule.

After milling, the mixture was dried in an oven for four hours, and then broken down to a powder consistency using a 200-mesh sieve or screen. Non-limiting examples of drying methods that may be used, but are not limited to, temperature assisted drying, spray drying, freeze drying and reduced pressure drying of the mixture.

### YAG Ceramic Test Discs

A uni-axial die press was used to form discs that had a diameter of about 2.5 cm and were 2 mm thick. Other shaping systems or methods may be used, for example, injection molding, extrusion systems, slip casting and pressing are commonly used in forming components for discharge lamp arc tubes. The discs were then heated at a temperature of 1050° C. for about two hours under atmospheric conditions to burn off any residual organic compounds or other contaminants, and later cooled to room temperature. This pre-firing may be carried out in the range of about 500° C. to about 1100° C. The pre-firing temperature and time cycle used will depend on the level of contaminants and the thickness of the ceramic samples.

The discs produced were determined to have a green density of about fifty percent (50%) to about sixty percent (60%) YAG. The term green density as used herein shall refer to the percentage of oxide powder mixture that makes up the volume of an article after that article has been formed and heated to burn off any contaminants, and prior to sintering.

Sintering of the discs, or of arc tube components as described below, may be conducted in or under reduced pressure (vacuum), ambient air, inert gas, reducing gas, oxidizing gas, or mixtures of such gases. Non-limiting examples of inert gases include, but are not limited to, argon and helium. Reducing gases include but are not limited to, dry or wet H₂, N₂, and CO/CO mixtures. Oxidizing gases include, but are not limited to, O₂ and O₃. Generally, sintering is conducted at a temperature in a range from about 1000° C. to about 2100° C. for a time ranging from 0.5 h to 24 h. The rate of heating to the sintering temperature may vary and should have no significant deleterious effect on the green body. Generally, heating rates are in a range from about 1° C./min to about 10° C./min. The controlled pressure used for sintering is in a range from about 10⁻⁸ torr to about 1.6×10⁶ torr. Sintering conditions are chosen to achieve a desired density and grain size, and depend on the particular materials system and thickness of the samples. Sintering conditions are also chosen to achieve complete pore filling, densification to a desired density value, and to confine the final grain size.

By way of example, the discs were sintered under vacuum to facilitate a solid-state reaction to produce the yttrium aluminum garnet ceramic. The discs were heated in a furnace at a pressure of about 10⁻⁵ torr. The temperature of the furnace was increased at a rate of 300° C./hour to 1300° C., which was maintained for a resident time of about two hours to five hours. The temperature was then increased at a rate of about 100° C./hour to 200° C./hour to 1500° C., which was maintained for a resident time ranging from about two hours to five hours. The temperature was then increased at a rate of about 100° C./hour to 200° C./hour to about 1800° C., which was maintained for a resident time of about five hours. Under these conditions, the mixture undergoes a solid-state reaction to form the yttrium aluminum garnet ceramic.

The discs were allowed to cool to room temperature. A particular rate of cooling was not used; one may incorporate different rates for cooling. The discs were then isostatic pressed under heat at 1800° C. at 25,000 psi for a resident time of about 2 hours. Other discs were isostatic pressed at room temperature; however, it has been determined that hot isostatic pressing may more efficiently remove residual porosity to achieve a higher level of transparency. In addition, the discs were annealed to remove any discoloration of the ceramic. For example, the discs were annealed at 1200° C. under atmospheric conditions for twenty-four hours.

The sintering schedule produced discs composed of ceramic YAG having grain sizes ranging from about 3 microns to about 10 microns. The in-line transmission of the discs was tested using a spectrophotometer that collected ultraviolet and infrared light in the visible light spectrum range of 400 nm to 800 nm. The discs consistently had an in-line transmission greater than 75% at a wavelength of 550 nm. Accordingly, the YAG made according to the foregoing method may achieve an in-line transmission of at least 75% for various known applications, and may reach an in-line transmission of greater than 75% if necessary for optical applications such as automotive headlamps. The term “in-line transmission” as used herein is understood to mean the ratio of the intensity of transmitted light to the intensity of incident light, obtained when a parallel beam of light of a certain intensity is incident perpendicular to the surface of a sample of given thickness. In the present embodiment, the in-line spectral transmission is determined on a polished plate of sintered body having a thickness of 1 mm at a wavelength of 554 nm.

### Formation of the Arc Tube

The above described oxide powder mixture and sintering schedule may also be used to fabricate arc tube components, including legs and arc bodies. After the mixture is dried the resulting mass is broken down into powder form. Prior to the sintering process, the arc body and legs is preferably formed by extrusion of a moldable mass formed by adding a binder, lubricant and water to the mixture. As noted above, other forming methods or systems, such as injection molding, slip casting or pressing may be used to form the components. An acceptable binder used to form the extruded parts is Zetag 7529, which may be obtained from Ciba Specialty Chemicals. The lubricant may be butyl stearate, which can be obtained from any one of several known sources. After the arc body is extruded, the arc body is heated at a temperature of 1050° C. for about two hours, under atmospheric conditions, in order to burn off contaminants including, but not limited to, the binder and lubricant.

### Co-sinter of YAG Arc Body and PCA Legs

The extruded arc body undergoes a sintering process to convert the yttrium oxide and aluminum oxide mixture into YAG. In addition, during co-sintering the legs and the arc body undergo differential shrinkage securing the legs and the arc body together. As described above the PCA legs may be pre-sintered at 1275° C. for about two hours. This pre-sintering step may be carried out at temperatures ranging from about 1000° C. to about 1600° C. under various time schedules. The selected temperature and the time schedule may depend on the size of the components and desired level of transparency required. The pre-sintering of the legs causes the legs to shrink about ten percent (10%) overall in size. In as much as the arc body is not pre-sintered, the oxide mixture making up the arc body is not converted to YAG, and the arc body has not shrunken.

After the components are cooled to room temperature, the legs are inserted into the arc body, and the components are co-sintered according to the above described sintering schedule. Arc tubes fabricated for testing generally included dimensions consistent with dimensions of HID lamps used as automotive headlamps. However, the dimensions of the arc tube and the components before and after sintering may differ from the below described dimensions depending on various known factors such as the field application of the arc tube, the dose composition used to generate light and the desired chamber size of the arc tube.

The components including the legs 12 and 13 and arc body 11 have a tubular configuration. Prior to the above-described pre-sintering, the legs 12 and 13 typically ranged from about 12 mm to about 15 mm in length and had an outside diameter of about 3 mm. The arc tube was also about 12 mm to about 15 mm in length, which arc tube had an outside diameter of 4.50 mm and an inside diameter of about 2.50 mm. Prior to sintering, the legs have an outside diameter of 2.88 mm and an inside diameter of 0.80 mm. During the pre-sintering stage, the outside diameter of the legs shrinks to about 2.49 mm.

The arc body 11 and legs 12 and 13 overlap one another by about 1 mm to 2 mm when the legs were inserted in the arc body 11. After sintering, the legs had an outside diameter of 2.14 mm and an inside diameter of 0.74 mm. After sintering the arc tube chamber had an outside diameter of 3.40 mm and inside diameter of about 2.14 mm.

The legs and arc body were sintered according to the following schedule. That is, the components were heated at a rate of 300° C./hour to 1300° C., which was maintained for a resident time of about two hours to five hours. Then the temperature is increased over a one to two hour period to 1500° C., which was maintained for a resident time ranging from about two hours to eight hours. The temperature was then increased over a three hour to six hour time period to about 1800° C., which was maintained for a resident time of about five hours. During this co-sintering process, the oxide mixture composing the arc body reacts to form YAG and shrinks onto the legs to form the arc tube.

As described above with respect to the ceramic discs, the arc tubes may also undergo hot isostatic pressing to remove any residual porosity in the YAG arc body. For example, the arc tube may be heated to 1800° C. at 25,000 psi for a resident time of about 2 hours. In addition, the arc tube may be annealed under atmospheric conditions at 1200° C. for about twenty-four hours to remove any discoloration in the ceramic material. Other annealing schedules may be used sufficient to accomplish this task.

The arc tube thus produced includes an arc body that is composed of sintered transparent yttrium aluminum garnet having the cross-sectional box-like configuration illustrated in FIG. 1. The arc body 11 has tubular middle wall 19 disposed between opposing end walls 17 and 18 forming the chamber 14. Each of the legs 12 and 13 is also tubular and each having an interior in communication with the chamber 14 for insertion of an electrode into the chamber 14. With respect to the arc body 11, the middle wall 19 is disposed substantially perpendicular with respect to each of the end walls 17 and 18. In addition, a longitudinal axis 21 of the legs 12 and 13 is substantially perpendicular to each of the end walls 17 and 18 of the arc body.

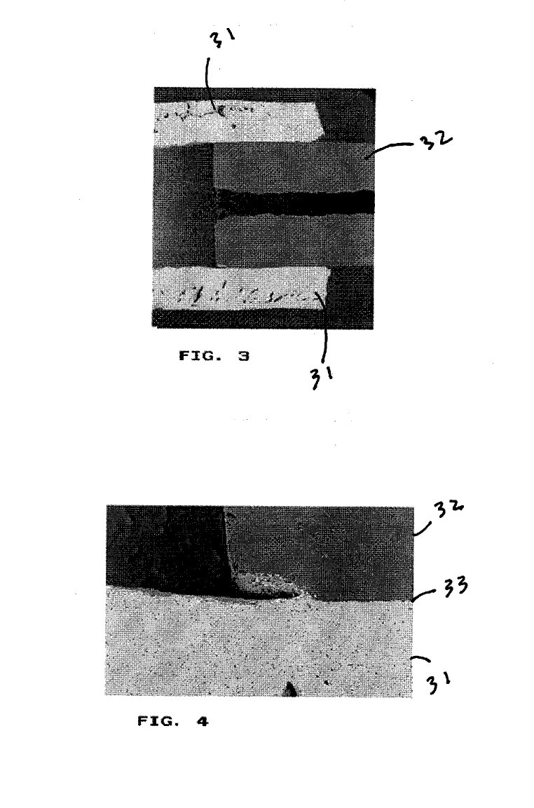

FIGS. 3 and 4 are photograph of a cross-section of an arc tube made from the above-described method and including a YAG arc tube 31 and PCA legs 32. These photographs illustrate the adhesion, or mechanical bonding, at the interface 33 between the YAG arc tube 31 and the PCA leg 32. During the co-sintering schedule yttrium aluminum garnet is created in the arc body from a solid-state reaction of the mixture of yttrium oxide and aluminum oxide, which shrinks more than the legs placing a compressive stress on the legs. This compressive stress drives diffusion between the material in the body and legs, effectively fusing the body and legs together. The reaction between the yttrium oxide and aluminum oxide takes place, in part, at the interface of the legs and arc body further enhancing the diffusion of the YAG and PCA at that area of the arc tube.

In addition, the coefficient of thermal expansion for each of the two different materials making up the legs and electrodes, and the two different ceramics making up the arc body and legs, are sufficiently matched thereby minimizing stresses at the interface between electrode and leg, and the interface between arc body and legs. For example, the coefficient of thermal expansion for PCA at 1000K, the operating temperature of the legs, is 7.88×10⁻⁶; and the coefficient of thermal expansion for the Mo—Re electrode is 6.05×10⁻⁵ at the same temperature. In addition, the coefficient of thermal expansion for YAG at 1200K, the operating temperature of the chamber at the interface, is 8.68×10⁻⁶; and, the coefficient of thermal expansion of PCA at the same temperature is 8.2×10⁻⁶. At least with respect to the two different ceramic materials making up the arc body and the legs, a difference in the value of the respective coefficient of thermal expansion should be as small as possible.

The assembly of the arc tube is completed using known materials and processes. More specifically, after the arc tube is formed an electrode is inserted into one of the legs, a dose of a desired discharge medium is injected into the arc tube through the same leg and a frit is inserted into the leg around the electrode. The arc tube is then heated according to a predetermined schedule and then cooled. The same procedure is followed for a second electrode and the other leg; thereby, sealing the discharge medium in the arc tube and adhering the electrodes to the legs.

The above-described embodiments for arc tubes comprise a combination of an arc tube composed YAG with legs composed of PCA. However, other materials may be used to fabricate a arc tube having an arc body composed of a first material and one or more legs attached to the arc copy, wherein the legs are composed of a second material. For example, the arc body may be composed of a first ceramic garnet material and the legs are composed of a second ceramic material. The term garnet includes a polycrystalline structure that is composed of, or comprises a compound having a formula Re₃Al₅O₁₂ where Re may be yttrium and/or one or more of the elements chosen from the lanthanide series (or rare earth metal series) such as lanthanum, cerium praseodymium, europium, gadolinium, terbium, dysprosium, holmium, erbium thulium, ytterbium and lutetium. Accordingly, in an embodiment of the invention the arc body comprises a first polycrystalline garnet material and the legs have a second polycrystalline garnet material wherein the Re of the first garnet material may be one or more of the above-listed elements, and the Re of the second garnet material includes one or more of the above listed elements, and at least one Re element of the first or second garnet material is different from the Re of the other garnet material. For example, the arc body may be composed of LuAG (Lu₃Al₅O₂), which includes lutetium, and the legs may be composed of YAG (Y₃Al₅O₂), which includes yttrium, but does not include lutetium. In another example, the arc body may comprise a combination YAG and LuAG, and the legs may comprise only YAG. In this manner, one may combine the advantages of different garnet materials to form a reliable ceramic material.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An arc tube for a high intensity discharge lamp, comprising:
an arc body comprising a single phase first ceramic material having a first elemental composition, and the arc body having a sealed chamber;
at least two legs attached to the arc body, and at least one of the legs comprising a single phase second ceramic material having a second elemental composition that is different from the first elemental composition; and,
at least two electrodes and each electrode is positioned within a respective leg, each electrode having a tip positioned within the chamber and the tips of the electrodes are spaced apart forming an arc region there between.

2. The arc tube of claim 1 wherein the first ceramic material of the arc body is yttrium aluminum garnet and the second ceramic material of the legs is polycrystalline alumina.

3. The arc tube of claim 1 wherein the first ceramic material and the second ceramic material are both polycrystalline ceramics.

4. The arc tube of claim 1 wherein the first ceramic material of the arc body has a first coefficient of thermal expansion and the second ceramic material of the legs has a second coefficient of thermal expansion that is different than the first coefficient of thermal expansion and the difference is up to 7% of the first coefficient of thermal expansion or second coefficient of thermal expansion.

5. The arc tube of claim 1 wherein at least one of the electrodes comprises a first section including the tip of the electrode that comprises tungsten, a second section that is disposed to a first section and a third section, and the second section comprises molybdenum and the third section comprises niobium.

6. The arc tube of claim 1 wherein at least one of the electrodes includes a first section including the tip of the electrode that comprises tungsten and a second section that comprises molybdenum and rhenium alloy.

7. An arc tube for a high intensity discharge lamp, comprising:
an arc body comprises a first ceramic material having a first coefficient of thermal expansion, and the arc body having a sealed chamber;
at least two legs attached to the arc body, and at least one of the legs comprises of a second ceramic material that has a coefficient of thermal expansion that is not equal to the first coefficient of thermal expansion; and,
at least two electrodes and each electrode is positioned within a respective leg, each electrode having a tip positioned within the chamber and the tips of the electrodes are spaced apart forming an arc region there between.

8. The arc tube of claim 7 wherein the first ceramic material of the arc body is yttrium aluminum garnet and the second ceramic material of the legs is polycrystalline alumina.

9. The arc tube of claim 7 wherein the first ceramic material and the second ceramic material both comprise polycrystalline ceramics.

10. The arc tube of claim 7 wherein a difference between the first coefficient of thermal expansion or second coefficient of thermal expansion is up to about 7%.

11. The arc tube of claim 7 wherein at least one of the electrodes comprises a first section including the tip of the electrode that comprises tungsten, a second section that is disposed to a first section and a third section, and the second section comprises molybdenum and the third section comprises niobium.

12. The arc tube of claim 7 wherein at least one of the electrodes includes a first section including the tip of the electrode that comprises tungsten and a second section that comprises molybdenum and rhenium alloy.

13. An arc tube for a high intensity discharge lamp, comprising:
an arc body comprising yttrium aluminum garnet ceramic, and the arc body having a sealed chamber, and the yttrium aluminum garnet having an in-line transmission of up to about 50%;
at least two legs attached to the arc body, and each of the legs comprising polycrystalline alumina ceramic; and,
at least two electrodes and each electrode is positioned within a respective leg, each electrode having a tip positioned within the chamber and the tips of the electrodes are spaced apart forming an arc region there between.

14. The arc tube of claim 13 wherein at least one of the electrodes comprises a first section including the tip of the electrode that comprises tungsten, a second section that is disposed to a first section and a third section, and the second section comprises molybdenum and the third section comprises niobium.

15. The arc tube of claim 13 wherein at least one of the electrodes includes a first section including the tip of the electrode that comprises tungsten and a second section that comprises molybdenum and rhenium alloy.

16. The arc tube of claim 13 wherein the yttrium aluminum garnet composing the arc body has an in-line transmission of up to 75%.

17. The arc tube of claim 13 wherein the yttrium aluminum garnet composing the arc body has an in-line transmission of up to 80%.

18. An arc tube for a high intensity discharge lamp, comprising:
an arc body comprising a single phase first ceramic material having a first elemental composition, and the arc body having a sealed chamber;
at least two legs attached to the arc body, and each of the legs comprising a single phase second ceramic material having a second elemental composition that is different from the first elemental composition of the ceramic material of the arc body; and,
at least two electrodes and each electrode is positioned within a respective leg, each electrode having a tip positioned within the chamber and the tips of the electrodes are spaced apart forming an arc region there between; and,
the chamber of the arc body is defined by a tubular middle wall and two opposing end walls and the middle wall is substantially perpendicular with respect to each of the end walls and each of the legs is connected to a respective end wall.

19. The arc tube of claim 18 wherein at least one of the electrodes comprises a first section including the tip of the electrode that comprises tungsten, a second section that is disposed to a first section and a third section, and the second section comprises molybdenum and the third section comprises niobium.

20. The arc tube of claim 18 wherein at least one of the electrodes includes a first section including the tip of the electrode that comprises tungsten and a second section comprises molybdenum and rhenium alloy.

21. The arc tube of claim 18 wherein the first ceramic material is yttrium aluminum garnet comprising the arc body and has an in-line transmission of at least 50%.

22. The arc tube of claim 18 wherein the yttrium aluminum garnet composing the arc body has an in-line transmission of at least 75%.

23. The arc tube of claim 18 wherein the yttrium aluminum garnet composing the arc body has an in-line transmission of at least 80%.

24. The arc tube of claim 18 wherein the arc body has an inside diameter between about 1.4 mm to about 5.0 mm.

25. The arc tube of claim 18 wherein the arc body has an inside diameter that is about 2.14 mm.

26. The arc tube of claim 18 wherein the arc body has a wall thickness that is about is about 0.3 mm to about 1.2 mm.

27. The arc tube of claim 18 wherein the arc body has a length of about 5 mm to about 16 mm.

28. The arc tube of claim 18 wherein the arc body has a length of about 10 mm to about 10.5 mm.

29. A method of manufacturing an arc tube for a high intensity discharge lamp, comprising:
sintering an arc body to a pair of legs wherein the arc body comprises a single phase first ceramic material having a first elemental composition, and at least one of the pairs of legs having a single phase second ceramic material having a second elemental composition that is different from the first elemental composition.

30. The method of claim 29 further comprising, after sintering the arc body to the legs, inserting an electrode into each of the pair of legs, injecting a discharge medium into the arc tube and sealing the chamber.

31. The method of claim 29 further comprising, before sintering the arc body to the legs, the steps of forming a moldable mass composed of a mixture of yttrium oxide powder and aluminum oxide powder into an arc body having one or more apertures, forming a moldable mass composed of polycrystalline alumina into one or more legs for an arc tube and inserting the legs into the one or more apertures of the arc body, whereby the mixture of yttrium oxide powder and aluminum oxide powder is converted into yttrium aluminum garnet during the sintering step.

32. The method of claim 31 further comprising the step of sintering the legs prior to inserting the legs into the arc body and before the step of sintering the arc body to the legs.

33. An arc tube for a high intensity discharge lamp, comprising:
an arc body comprising a first polycrystalline garnet material having a first elemental composition, and the arc body having a sealed chamber;
at least two legs attached to the arc body, and at least one of the legs comprising a second polycrystalline material a second elemental composition that is different from the first elemental composition; and,
at least two electrodes and each electrode is positioned within a respective leg, each electrode having a tip positioned within the chamber and the tips of the electrodes are spaced apart forming an arc region there between.

34. The arc tube of claim 33 wherein the first garnet material and the second garnet each has an elemental formula that is Re₃Al₅O₁₂ wherein Re is yttrium and/or one or more elements of the lanthanide series, and Re for first garnet material includes one or more elements that is not the Re for the second garnet material.

35. The arc tube of claim 33 wherein the first garnet material comprises yttrium aluminum garnet and second garnet material comprises lutetium aluminum garnet.

36. The arc tube of claim 33 wherein the first garnet material comprises lutetium aluminum garnet and second garnet material comprises yttrium aluminum garnet.
